(19) United States
(12) Patent Application Publication
(10) Pub. No.: US 2007/0116363 A1
(43) Pub. Date: May 24, 2007

(54) Image processing device, image processing method, and storage medium storing image processing program

(75) Inventor: Hiroshi Iida, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/448,943

(22) Filed: Jun. 8, 2006

(30) Foreign Application Priority Data
Nov. 22, 2005 (JP) 2005-337308

(51) Int. Cl. G06K 9/18; G06K 9/34; G06K 7/10

(52) U.S. Cl. 382/182; 382/173; 382/321

(57) ABSTRACT

An image processing device includes an inputting unit, an extracting unit, a reading unit and processing unit. The inputting unit converts, into a format which can be processed within the image processing device, and inputs, digitized document data for region designation that includes region information expressing a region which has been designated in advance in order to carry out a predetermined processing. The extracting unit extracts the region information from the document data for region designation and the reading unit reads a document image for carrying out the predetermined processing. The processing unit extracts, from the document image read by the reading unit, a region corresponding to the region information extracted by the extracting unit, and carries out the predetermined processing.

### CROSS-REFERENCE TO RELATED APPLICATION

This application claims priority under 35 U.S.C. 119 from Japanese Patent Application No. 2005-337308, the disclosure of which is incorporated by reference herein.

### BACKGROUND

1. Technical Field

The present invention relates to an image processing device, an image processing method, and a storage medium storing an image processing program, and in particular, relates to an image processing device, an image processing method, and a storage medium storing an image processing program that carry out OCR (Optical Character Recognition) processing on a designated region.

2. Related Art

In cases in which a region is designated on a sheet, on which a document image or the like is recorded, and OCR processing is carried out, there are methods such as a method of designating a rectangular region by a mouse or the like by using a GUI (Graphical User Interface) or the like, a method in which a region to be subjected to OCR processing is set in advance and is used as a template, and the like.

### SUMMARY

An image processing device of a first aspect of the present invention includes: a reception unit that receives document data for region designation which includes region information expressing a region of the document data, the region is a target of a processing of the image processing device, and converts the document data into a format which can be processed by the image processing device; an extracting unit that extracts the region information from the document data for region designation; a reading unit that reads a document image; and a processing unit that extracts, from the document image read by the reading unit, a region corresponding to the region information extracted by the extracting unit, and carries out the processing to the region of the document image.

### BRIEF DESCRIPTION OF THE DRAWINGS

An embodiment of the present invention will be described in detail based on the following figures, where:

FIG. 1 is a diagram showing the structure of an image processing device relating to an embodiment of the present invention;

FIG. 2 is a flowchart showing an example of the flow of region designating processing which sets a region to be subjected to OCR from an external computer or the like, with respect to the image processing device relating to the embodiment of the present invention;

FIG. 3 is a flowchart showing an example of the flow of region registering processing which registers a region to be subjected to OCR processing and which is carried out at the image processing device relating to the embodiment of the present invention; and

FIG. 4 is a flowchart showing an example of the flow of OCR processing carried out at the image processing device relating to the embodiment of the present invention.

### DETAILED DESCRIPTION

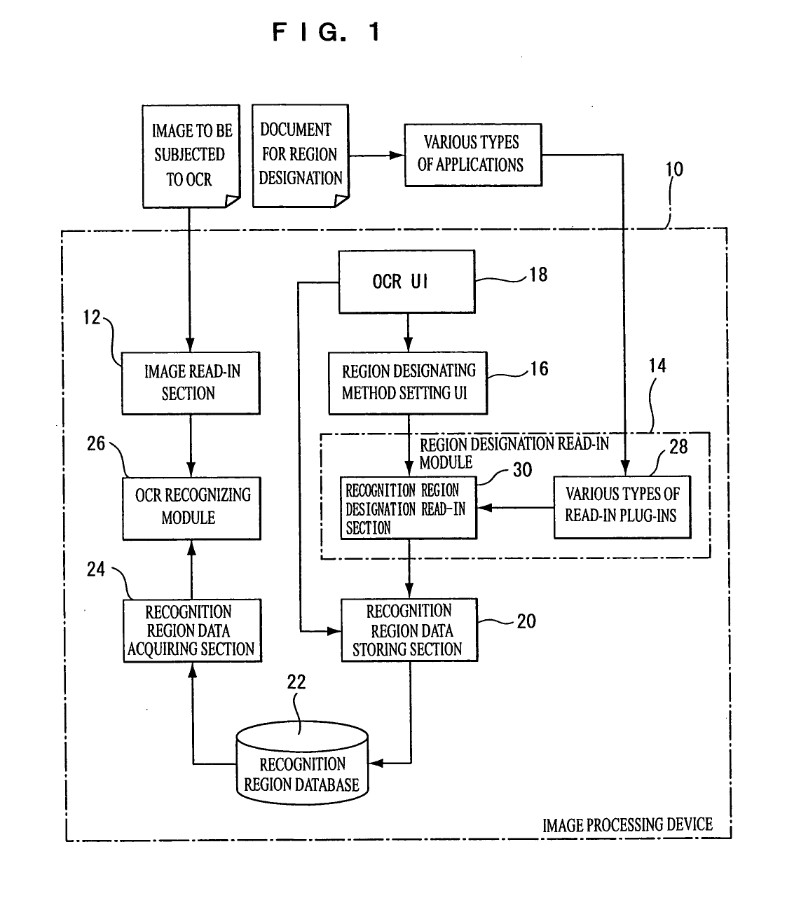

An example of an embodiment of the present invention will be described in detail hereinafter with reference to the drawings. FIG. 1 is a diagram showing the structure of an image processing device relating to the embodiment of the present invention.

As shown in FIG. 1, an image processing device 10 relating to an embodiment of the present invention has an image read-in section 12, a region designation read-in module 14, a region designating method setting UI (User Interface) 16, an OCR UI (User Interface) 18, a recognition region data storing section 20, a recognition region database 22, a recognition region data acquiring section 24, and an OCR recognizing module 26.

The image read-in section 12 reads-in image data which has been prepared by making a paper document, which is to be subjected to OCR processing (e.g., a document of a fixed form, such as a business form or the like), electronic by using a scanner or a fax machine or the like.

The region designation read-in module 14 acquires a document for region designation which has been prepared by making a paper document or the like digitized, or acquires a document for region designation which has been prepared by various types of application software. The document for region recognition includes region information which is to be the object of OCR processing and which is designated by using various types of application software (e.g., information which designates a region such as a frame, a color, a color marker, or the like which can be used in application software). The region designation read-in module 14 extracts, from the document for region designation, the region which is to be the object of OCR processing and which is designated by various types of application software. Note that the region designation read-in module 14 may acquire a document for region designation which has been prepared by digitizing a paper document or the like in which a region, which is to be the object of OCR processing and which has been designated by handwritten marks or the like (e.g., a frame or a color marker or the like), is designated.

The region designation read-in module 14 is structured by various types of read-in plug-ins 28 and a recognition region designation read-in section 30.

The various types of read-in plug-ins 28 convert data of formats which are used at the various types of application software and the like, into formats which can be processed at the image processing device 10, and input them into (take them into) the image processing device 10. The various types of read-in plug-ins 28 include, for example, an image read-in plug-in module which reads-in image data (the document for region designation) which has been prepared by digitizing a paper document in which a region which is to be an object of OCR processing is designated by handwriting or the like (e.g., the OCR object region is designated by handwriting such as a rectangular frame or a color marker or the like), and which reads-in image data (the document for region designation) which has been prepared by digitizing a paper document and in which the region which is to be the object of OCR processing is designated by various types of image editors or the like; a plug-in module which reads-in a PPT document in which the region which is to be the object of OCR processing is designated by the software Power Pointer (PPT) by Microsoft Corporation; a plug-in module which reads-in a Word document in which the region which is to be the object of OCR processing is designated by the software Word by Microsoft Corporation; a plug-in module which reads-in an XDW document in which the region which is to be object of OCR processing is designated by the software Docuworks (XDW) by Fuji Xerox Co., Ltd.; and the like. Note that the various types of plug-ins 28 are not limited to the above-described plug-in modules, and other plug-in modules may be used.

The recognition region designation read-in section 30 reads-in the document for region designation from the various types of plug-ins 28 in accordance with settings designated at the region designating method setting UI 16, and extracts the region which is to be the object of OCR processing.

The processing method at the time of reading-in the region from the various types of read-in plug-ins 28 is set by the region designating method setting UI 16. A processing method, which has a setting such as, for example, rectangular frame, colored-in region, color designation, automatic, or the like and which is for extracting the region which is to be the object of OCR processing in accordance with the setting, is designated as the processing method to be set. Note that settings such as type of document to be read-in, or the like, may be carried out.

The OCR UI 118 carries out inputting of index information (e.g., rules applied for image data which is acquired from a given device, or the like) for the region which is to be the object of OCR processing which is extracted by the recognition region designation read-in section 30, and carries out inputting for carrying out the selection of the processing method set at the region designating method setting UI 16, and the like. The recognition region data storing section 20 stores, in the recognition region database 22 and in association with one another, the index information inputted by the OCR UI 18 and region information which expresses the region (recognition region) which is to be the object of OCR processing extracted by the recognition region designation read-in section 30. Note that, instead of the recognition regions stored in the recognition region database 22 being region information, the recognition region data themselves may be stored in the recognition region database 22 in association with the index information.

The recognition region data acquiring section 24 generates index data (index information) from region selecting information inputted from an external UI or system (e.g., information of the device reading the image to be subjected to OCR), and selects and acquires the region information corresponding to the index data (index information) from the data stored in the recognition region database 22.

The OCR recognizing module 26 acquires, from the image read-in section 12, the image data which has been prepared by making electronic the paper document which is to be subjected to OCR processing (e.g., a document of a fixed form, such as a business form or the like). The OCR recognizing module 26 also acquires the region information which the recognition region data acquiring section 24 has acquired, and executes OCR processing on the region corresponding to the region information from the image data acquired from the image read-in section 12.

Next, the processing which is carried out at the image processing device 10 relating to the embodiment of the present invention, which is structured as described above, will be described.

First, the region designating processing at the time of registering the object of OCR processing with respect to the image processing device 10 which is structured as described above, will be described. Note that explanation will be given hereinafter of a case of designating a region to be subjected to OCR processing by using various types of application software which are installed in a computer or the like other than the image processing device 10.

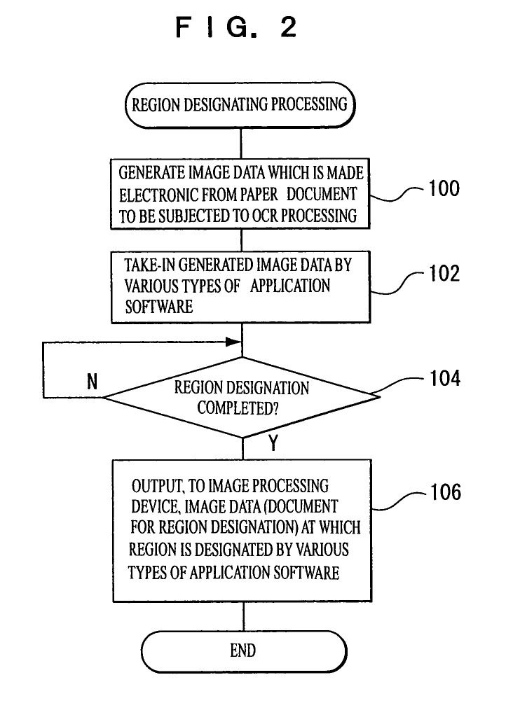

FIG. 2 is a flowchart showing an example of the flow of region designating processing which sets a region to be subjected to OCR from an external computer or the like, with respect to the image processing device 10 relating to the embodiment of the present invention.

First, in step 100, image data which is made electronic is generated from the paper document to be subjected to OCR processing, and the routine moves on to step 102. Namely, the paper document to be subjected to OCR processing is read-in by a scanner or the like and is made to be electronic, such that image data is generated.

In step 102, the generated image data is taken-in by the various types of application software (e.g., the aforementioned PPT, Word, XDW, or the like), and the routine moves on to step 104.

In step 104, it is judged whether or not the designating of the region to be subjected to OCR processing has been completed for the image data by using the various types of application software. This judgment is a judgment as to whether or not the designation of the region to be subjected to OCR has been completed at the various types of application software and the image processing device 10 has been instructed to register the designated region, or the like. If this judgment is negative, the routine stands-by until the judgment becomes affirmative, and then moves on to step 106. Namely, because the region to be subjected to OCR processing is designated at the various types of application software, region designation using an application software which the user is used to is possible. Note that the region designation at the application software may be the designation of the region by using, for example, a frame, color, color marker, or the like which may be used at the various types of application software.

In step 106, the image data at which the region is designated by the various types of application software (i.e., the document for region designation) is outputted to the image processing device 10, and the series of processings ends.

Note that, other than designating the region to be subjected to OCR processing by using the various types of application software installed in an external computer as described above, it is possible to generate the document for region designation by making electronic a paper document at which the designation is handwritten by a rectangle or a color marker or the like.

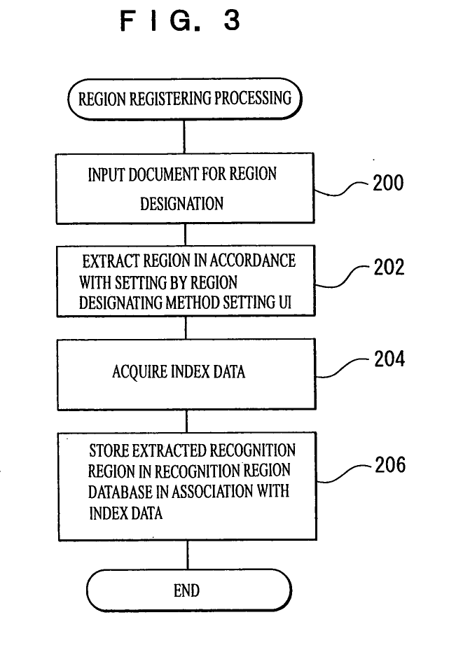

FIG. 3 is a flowchart showing an example of the flow of region registering processing which registers a region to be subjected to OCR processing and which is carried out at the image processing device 10 relating to the embodiment of the present invention.

In step 200, the document for region designation, at which the region to be subjected to OCR processing was designated by the various types of application software as described above, is inputted, and the routine proceeds to step 202. In accordance with the setting designated at the region designating method setting UI 16 for example, the recognition region designation read-in section 30 takes-in the document for region designation which was outputted from the computer or the like, via the various types of read-in plug-ins 28 into the image processing device 10. At this time, if the document type is not designated at the region designating method setting UI 16, the document type is judged from the extension of the designated document or the like, and the document for region designation is read-in via the various types of read-in plug-ins 28.

In step 202, the region is extracted in accordance with the setting by the region designating method setting UI 16, and the routine moves on to step 204. Namely, by carrying out setting at the region designating method setting UI 16 so as to extract the region which was designated by the region designating processing, the recognition region designation read-in section 30 extracts, from the document for region designation, the region which was designated by the region designating processing (hereinafter, the region designated by the region designating processing will be called the recognition region).

In step 204, the index data (index information) for specifying the extracted recognition region is acquired, and the routine proceeds to step 206. The acquisition of the index data (index information) is carried out by the recognition region data storing section 20 acquiring it from the OCR UI 18. For example, if the image to be subjected to OCR is read-in from a predetermined device by the image read-in section 12, the user prepares rules for selecting the predetermined recognition region as index data (index information) by using the OCR UI 18, and the recognition region data storing section 20 acquires it.

In subsequent step 206, the extracted recognition region is stored in the recognition region database 22 in association with the index data (index information), and the series of region registering processings ends. In this way, in a case in which the image which is to be subjected to OCR is read-in by the image read-in section 12 from a predetermined device, the corresponding recognition region can be selected automatically by retrieving the corresponding index data (index information).

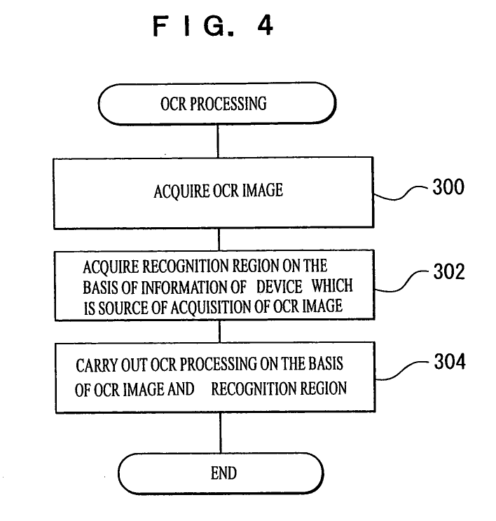

Processing in the case of carrying out OCR processing at the image processing device 10 relating to the embodiment of the present invention will be described next. FIG. 4 is a flowchart showing an example of the flow of OCR processing carried out at the image processing device 10 relating to the embodiment of the present invention.

In step 300, the OCR image is acquired, and the routine moves on to step 302. Namely, the image data, which has been prepared and made electronic by reading-in, by a scanner or a fax machine or the like, the paper document to be subjected to OCR processing (e.g., a document of a fixed form, such as a business form or the like), is acquired by the OCR recognizing module 26 via the image read-in section 12.

In step 302, the recognition region is acquired on the basis of the information of the device which is the source of acquisition of the OCR image, and the routine proceeds to step 304. Namely, the recognition region data acquiring section 24 retrieves, from the recognition region database 22, and acquires the recognition region which is associated with the index information corresponding to the device information.

In step 304, OCR processing is executed on the basis of the image data expressing the OCR image which the OCR recognizing module 26 acquired and the region information which the recognition region data acquiring section 24 acquired, and the series of OCR processings ends. Namely, the portion corresponding to the recognition region is extracted from the OCR image, and predetermined OCR processing is carried out on this extracted portion.

For example, because the region may be designated by a rectangular frame on the image, reading-in a document by a usual fax machine or scanner or the like and stating the recognition region on that image may be supposed. The region which is to be recognized may be designated clearly.

Further, because color designation such as by a marker or the like can be used in designating the region, even in document in which there are a large number of rectangular frames such as tables or the like, it can easily be judged which region has been designated.

Because it is possible to not add any editing at all to the document used in the region designation, the document for region designation can be managed by a managing method which is particular to a user, and it is possible to reuse a document which has been used in region designation. Moreover, even at times when the designated region changes due to changes in the standard processing or the like, the document which is used in the region designation can be reused, and therefore, re-designation of the region is easy.

The data which is stored by the recognition region data storing section 20 is recognition regions which are designated by various types of application software. Therefore, the data can be utilized even if the image processing device 10 or the software in the image processing device 10 or the like is changed.

The image read-in section 12, the region designation read-in module 14, the region designating method setting UI 16, the recognition region data storing section 20, the recognition region data acquiring section 24, and the OCR recognizing module 26 in the above-described embodiment may be structured by hardware, or may be structured by software. Namely, the above-described region registering processing and OCR processing which are carried out at the image processing device 10 may be processings which are carried out by hardware, or may be processings which are carried out by software.

A specific embodiment of the present invention has been described above, but the present invention is not limited to this embodiment.

Namely, a first aspect of the present invention provides an image processing device which includes: an inputting unit that converts digitized document data for region designation that includes region information expressing a region which has been designated in advance in order to carry out a predetermined processing into a format which can be processed within the image processing device and inputs the document data; an extracting unit that extracts the region information from the document data for region designation; a reading unit that reads a document image for carrying out the predetermined processing; and a processing unit that extracts, from the document image read by the reading unit, a region corresponding to the region information extracted by the extracting unit, and carries out the predetermined processing.

In accordance with the above-described first aspect, at the inputting unit, document data for region designation, which has been digitized (made electronic) and which includes region information expressing a region which has been designated in advance in order to carry out a predetermined processing, is converted into a format which can be processed within the image processing device, and is inputted. At the extracting unit, region information is extracted from the document data for region designation which was inputted by the inputting unit.

For example, document data for region designation, in which a region for carrying out a predetermined processing is designated by using various types of application software, can be inputted to the image processing device by the inputting unit. This region information can be extracted by the extracting unit.

Further, a document image for carrying out the predetermined processing is read at the reading unit. At the processing unit, a region, which corresponds to the region information extracted by the extracting unit, is extracted from the document image read by the reading unit, and the predetermined processing (e.g., OCR processing) is carried out.

Namely, by using an application software or the like which a user is used to using, the user designates the region at which the predetermined processing is to be carried out. At the time when the predetermined processing is carried out, the predetermined processing can be carried out automatically on the designated region. Therefore, the designation of a region at which a predetermined processing, such as OCR processing or the like, is to be carried out, can be carried out easily.

The image processing device of the first aspect may further have: a storing unit storing the region information extracted by the extracting unit, in association with index information which relates to a source of reading (reading object portion) of the reading unit; an acquiring unit acquiring the index information from the source of reading of the reading unit, at a time of reading a document image by the reading unit; and a retrieving unit retrieving, from the storing unit, the region information corresponding to the index information acquired by the acquiring unit, wherein the processing unit extracts, from the document image read by the reading unit, a region corresponding to the region information retrieved by the retrieving unit and carries out a predetermined processing.

The document data for region designation may include region information designated by at least one of a predetermined frame and color (e.g., a color marker or the like), or may include region information designated by predetermined application software.

A second aspect of the present invention is provided by an image processing method which includes: converting digitized document data for region designation that includes region information expressing a region which has been designated in advance in order to carry out a predetermined processing into a format which can be processed and inputting the document data; extracting the region information from the inputted document data for region designation; reading a document image for carrying out the predetermined processing; and extracting, from the read document image, a region corresponding to the extracted region information, and carrying out the predetermined processing.

In the second aspect, in the inputting step, document data for region designation, which has been digitized (made electronic) and which includes region information expressing a region which has been designated in advance in order to carry out a predetermined processing, is converted into a format which can be processed within the device itself and is inputted. In the extracting step, the region information is extracted from the document data for region designation which was inputted in the inputting step.

For example, document data for region designation, in which a region for carrying out a predetermined processing is designated by using various types of application software, can be inputted by the inputting step. This region information can be extracted by the extracting step.

Then, in the reading step, a document image for carrying out a predetermined processing is read. In the processing step, a region corresponding to the region information extracted in the extracting step is extracted from the document image read in the reading step, and a predetermined processing (e.g., OCR processing) is carried out.

Namely, by using an application software or the like which the user is used to using, the user designates the region at which the predetermined processing is to be carried out. At the time when the predetermined processing is carried out, the predetermined processing can be carried out automatically on the designated region. Therefore, the designation of a region at which a predetermined processing, such as OCR processing or the like, is to be carried out, can be carried out easily.

The image processing method of the second aspect may further comprise: a storing step of storing the region information extracted in the extracting step, in association with index information relating to the source of reading of the reading step; an acquiring step of acquiring index information from the source of reading of the reading step, at the time when the document image is read in the reading step; and a retrieving step of retrieving, from among the region information stored in the storing step, region information corresponding to the index information which was acquired in the acquiring step. The processing step may extract, from the document image read in the reading step, a region corresponding to the region information retrieved in the retrieving step, and may carry out a predetermined processing.

The document data for region designation may include region information designated by at least one of a predetermined frame and color, or may include region information designated by predetermined application software.

As a third aspect, the present invention provides a storage medium storing an image processing program causing a computer to execute the respective steps of the above-described image processing method.

What is claimed is:

1. An image processing device comprising:
a reception unit that receives document data for region designation which includes region information expressing a region of the document data, the region is a target of a processing of the image processing device, and converts the document data into a format which can be processed by the image processing device;
an extracting unit that extracts the region information from the document data for region designation;
a reading unit that reads a document image; and
a processing unit that extracts, from the document image read by the reading unit, a region corresponding to the region information extracted by the extracting unit, and carries out the processing to the region of the document image.

2. The image processing device of claim 1, further comprising:
a storing unit that stores the region information extracted by the extracting unit, in association with index information;
an acquiring unit that acquires the index information when the reading unit reads the document image; and
a retrieving unit that retrieves, from the storing unit, the region information corresponding to the index information acquired by the acquiring unit,
wherein the processing unit extracts, from the document image read by the reading unit, a region corresponding to the region information retrieved by the retrieving unit and carries out the processing.

3. The image processing device of claim 1, wherein the document data for region designation includes region information designated by at least one of a frame and color.

4. The image processing device of claim 1, wherein the document data for region designation includes region information designated by application software.

5. The image processing device of claim 1, wherein the processing by the image processing device includes optical character recognition processing.

6. An image processing method comprising:
receiving document data for region designation which includes region information expressing a region of the document data, the region is a target of a predetermined processing;
converting the document data into a format which can be processed;
extracting the region information from the document data for region designation;
reading a document image;
extracting, from the read document image, a region corresponding to the extracted region information; and
carrying out the predetermined processing to the region of the document data.

7. The image processing method of claim 6, further comprising:
acquiring index information when reading the document image;
storing the extracted region information in association with the index information; and
retrieving, from among the stored region information, the region information corresponding to the index information,
wherein the predetermined processing includes extracting, from the read document image, a region corresponding to the retrieved region information.

8. The image processing method of claim 6, wherein the document data for region designation includes region information designated by at least one of a frame and color.

9. The image processing method of claim 6, wherein the document data for region designation includes region information designated by application software.

10. The image processing method of claim 6, wherein the predetermined processing includes optical character recognition processing.

11. A storage medium readable by a computer storing an image processing program executable by the computer to perform a function comprising:
receiving document data for region designation which includes region information expressing a region of the document data, the region is a target of a predetermined processing;
converting the document data into a format which can be processed;
extracting the region information from the document data for region designation;
reading a document image;
extracting, from the read document image, a region corresponding to the extracted region information; and
carrying out the predetermined processing to the region of the document data.

12. The storage medium of claim 11, the function further comprising:
acquiring index information when reading the document image;
storing the extracted region information in association with the index information; and
retrieving, from among the stored region information, the region information corresponding to the index information,
wherein the predetermined processing includes extracting, from the read document image, a region corresponding to the retrieved region information.

13. The storage medium of claim 11, wherein the document data for region designation includes region information designated by at least one of a frame and color.

14. The storage medium of claim 11, wherein the document data for region designation includes region information designated by application software.

15. The storage medium of claim 11, wherein the predetermined processing includes optical character recognition processing.
